(19) United States
(12) Patent Application Publication
(10) Pub. No.: US 2017/0061039 A1
(43) Pub. Date: Mar. 2, 2017

(54) COMPUTER-IMPLEMENTED SYSTEM AND METHOD FOR PLACING OBJECTS IN A ROOM

(71) Applicant: Aditazz, Inc., Brisbane, CA (US)

(72) Inventors: Sydney Sweeney, Brisbane, CA (US); Sudha Hajela, Brisbane, CA (US); Sophia Lin, Brisbane, CA (US); Ibrahim Algwaiz, Brisbane, CA (US); Robert Yu, Fremont, CA (US)

(73) Assignee: Aditazz, Inc., Brisbane, CA (US)

(21) Appl. No.: 15/245,799

(22) Filed: Aug. 24, 2016

Related U.S. Application Data
(60) Provisional application No. 62/209,291, filed on Aug. 24, 2015.

(51) Int. Cl. G06F 17/50

(52) U.S. Cl. CPC G06F 17/5004

(57) ABSTRACT

A method and system for generating a room plan are disclosed. In the embodiment, the method involves determining objects to be placed in a room, defining relationships between the objects in the room using Room Service Rules, parsing the Room Service Rules, and generating a room plan by passing the parsed Room Service Rules to a content placer, wherein Room Service Rules are parsable entries that correspond to spatial relationships of the objects to be placed in the room.

### BACKGROUND

When designing a building, architects may develop room plans to illustrate how and where objects will be situated in a room in the building. For example, when designing a recovery wing of a hospital, an architect may create a room plan that indicates where objects, such as a patient bed, should be positioned in the room. When determining how to place an object in a room, the architect typically must consider a number of factors beyond those imposed by the physical dimensions of the room. For example, in addition to making sure that the dimensions of the patient bed are such that the bed can fit in the room, the architect may also need to make sure that the patient bed is placed along a wall opposite to the entrance to the room. Additionally, a typically room contains multiple objects. Placing each object in a room plan involves similar considerations as those described for the patient bed. Thus, because developing a room plan is more complex than simply making sure that objects physically fit in a room (e.g., the patient bed cannot be longer than the width and length of the room), the development process can become very labor intensive and time consuming.

### SUMMARY

In accordance with an embodiment of the invention, a method for generating a room plan is disclosed. In the embodiment, the method involves determining objects to be placed in a room, defining relationships between the objects in the room using Room Service Rules, parsing the Room Service Rules, and generating a room plan by passing the parsed Room Service Rules to a content placer, wherein Room Service Rules are parsable entries that correspond to spatial relationships of the objects to be placed in the room.

In another embodiment, the Room Service Rules comprise a set of parameterized rule statements that allow a user to pass relationship data to a solver.

In another embodiment, the relationships between the objects in the room can be pre-defined based on a profile.

In another embodiment, the relationships between the objects in the room can be pre-defined based on a room type.

In another embodiment, an error is reported if no placement of the objects in the room is possible.

In a second embodiment, a computer-implemented system for defining relationships between objects that are to be included in a room of a building system within which healthcare services will be provided to patients is disclosed. In the embodiment, the computer-implemented system is configured to identify a first object with a handle, wherein the first object is at least one of furniture, fixtures, and equipment, identify a second object with a handle, and define a spatial relationship between the first object and the second object using a spatial relationship statement, wherein the handle of the first object, the handle of the second object, and the spatial relationship statements are inserted into fields of a parameterized Room Service Rule that can be parsed by a computer-based implementation system.

In another embodiment, a handle identifies an object by at least one of a vertex, an edge, and a face.

In another embodiment, spatial relations are at least one of a relationship with a wall, a separation, an alignment, a distribution, a light of sight, and a rotation relationship.

In another embodiment, the handle indicates a set of one or more objects.

In another embodiment, the system is further configured to pass relationship data to a solver.

In another embodiment, the second object identified is inherent to the Room Service Rule used to define the relationship.

In another embodiment, an object can be a group of objects with defined relationships between the objects in the group.

In a third embodiment, a method for verifying a room plan is disclosed. In the embodiment, the method involves defining a first set of Room Service Rules describing the placement of objects within a room plan, defining a second set of Room Service Rules based on client-provided constraints, parsing the Room Service Rules, and verifying that the first set of Room Service Rules satisfy the second set of Room Service rules.

In another embodiment, the Room Service Rules comprise a set of parameterized rule statements that allow a user to pass relationship data to a solver.

In another embodiment, the first set of Room Service Rules can be pre-defined based on a profile.

In another embodiment, the second set of Room Service Rules can be pre-defined based on a profile.

In another embodiment, the relationships between the objects in the room can be pre-defined based on a room type.

In another embodiment, the second set of Room Service Rules specify an acceptable range into which rules in the first set of Room Service Rules can fall.

In another embodiment, a method for generating a room plan for a room of a building system within which healthcare services will be provided to patients is disclosed. In the embodiment, the method involves determining objects to be placed in a room, defining relationships between the objects in the room using Room Service Rules, parsing the Room Service Rules, and generating a room plan by passing the parsed Room Service Rules to a content placer wherein Room Service Rules are parsable entries that correspond to spatial relationships of the objects to be placed in the room.

In another embodiment, the Room Service Rules comprise a set of parameterized rule statements that allow a user to pass relationship data to a solver.

In another embodiment, the relationships between the objects in the room can be pre-defined based on a profile.

In another embodiment, the relationships between the objects in the room can be pre-defined based on a room type.

In another embodiment, an error is reported if no placement of the objects in the room is possible.

In another embodiment, a computer-implemented system for defining relationships between objects that are to be included in a room plan is disclosed. In the embodiment, the computer-implemented system configured to identify a first object with a handle, wherein the first object is at least one of furniture, fixtures, and equipment, identify a second object with a handle, and define a spatial relationship between the first object and the second object using a spatial relationship statement wherein the handle of the first object, the handle of the second object, and the spatial relationship statements are inserted into fields of a parameterized Room Service Rule that can be parsed by a computer-based implementation system.

In another embodiment, a handle identifies an object by at least one of a vertex, an edge, and a face.

In another embodiment, spatial relations are at least one of a relationship with a wall, a separation, an alignment, a distribution, a light of sight, and a rotation relationship.

In another embodiment, the handle indicates a set of one or more objects.

In another embodiment, the system is further configured to pass relationship data to a solver.

In another embodiment, the second object identified is inherent to the Room Service Rule used to define the relationship.

In another embodiment, an object can be a group of objects with defined relationships between the objects in the group.

Other aspects and advantages of embodiments of the present invention will become apparent from the following detailed description taken in conjunction with the accompanying drawings.

### BRIEF DESCRIPTION OF THE DRAWINGS

FIG. 1 is a room plan indicating a possible placement of objects.

FIG. 2 is a flow chart diagram of information passed to a content placer that is configured to generate a room plan in accordance with an embodiment of the invention.

FIG. 3 illustrates the format of a Room Service Rule in accordance with an embodiment of the invention.

FIG. 4 is a table of spatial relationship statements in accordance with an embodiment of the invention.

FIG. 5A illustrates an object box and FIGS. 5B-5D illustrate how different handles identify the geometry of the object box in accordance with an embodiment of the invention.

FIGS. 6A-6B are a set of Room Service Rules that describe the room plan of FIG. 1 in accordance with an embodiment of the invention.

FIG. 7 is a flow chart diagram of a method for generating a room plan in accordance with an embodiment of the invention.

FIG. 8 is a flow chart diagram of a method for verifying a room plan in accordance with an embodiment of the invention.

FIG. 9 illustrates a computer having a display device in accordance with an embodiment of the invention

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

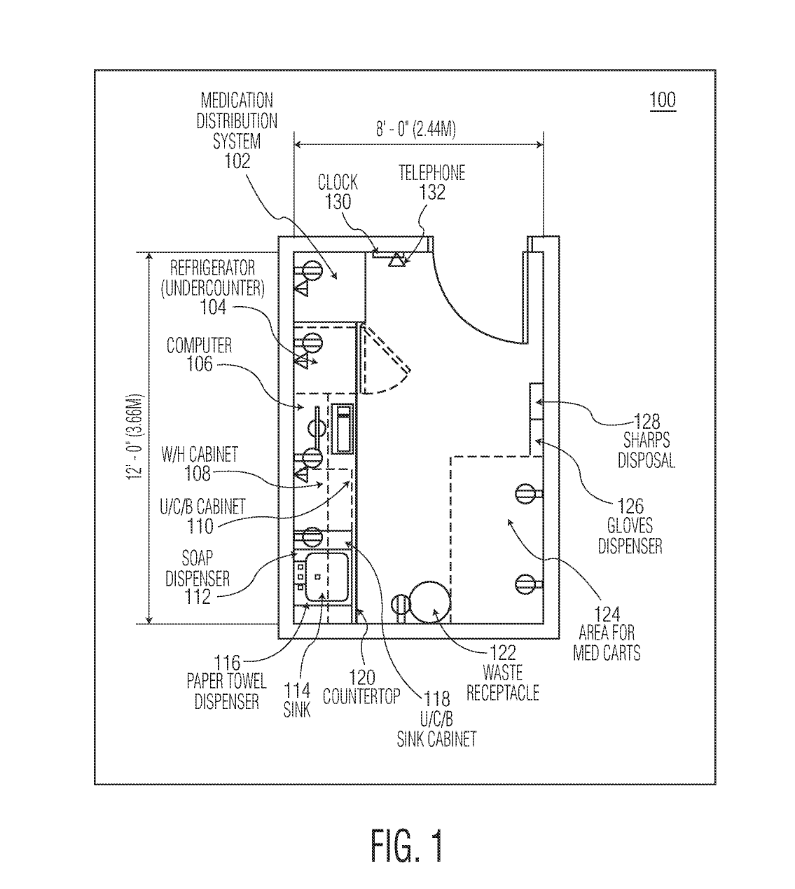

As described above, when an architect is designing a building, the architect may develop room plans to illustrate how and where objects will be situated in a room in the building. FIG. 1 is a room plan 100 indicating a possible placement of objects in the room. In the example of FIG. 1, a medication distribution system 102, a refrigerator 104, a computer 106, a wall hung (W/H) cabinet 108, an under-cabinet base (U/C/B) cabinet 110, a soap dispenser 112, a sink 114, a paper towel dispenser 116, a U/C/B sink cabinet 118, a countertop 120, a waste receptacle 122, an area for med carts 124, a gloves dispenser 126, a sharps disposal 128, a clock 130, and a telephone 132 have been placed in the room. The objects are placed in the room, at least, such that the objects physically fit in space of the room, but the placement is further guided by a set of constraints. For example, the refrigerator is below the countertop and the paper towel dispenser is to the left of the sink.

Often, when an architect is designing a building, the dimensions of a building can be irregular (e.g., because a preexisting building is being repurposed, because the plot on which the building is built is irregular, because the structural elements of the building interrupt a floor plan, etc.) and, thus, similar types of rooms may be designed differently to best utilize the space within a building. For example, if the building has an angled wall, then each room may have different wall dimensions, even if the total area is kept constant. Because rooms may have different dimensions, it is often insufficient to develop a single room plan to be used by every room of the same type, because objects may need to be placed differently in each room plan given the different dimensions. Thus, the architect may have to engage in a tedious and often time-consuming process of developing several room plans.

Alternatively, the development of room plans can be automated by a content placer in order to save time and even accelerate the building design process in accordance with an embodiment of the invention. In accordance with an embodiment of the invention, a method for generating a room plan is disclosed. In the embodiment, the method involves determining objects to be placed in a room, defining relationships between the objects in the room using Room Service Rules, parsing the Room Service Rules, and generating a room plan by passing the parsed Room Service Rules to a content placer, wherein Room Service Rules are parsable entries that correspond to spatial relationships of the objects to be placed in the room. That is, a content placer parses Room Service Rules and generates a room plan indicating a possible placement of objects within a room.

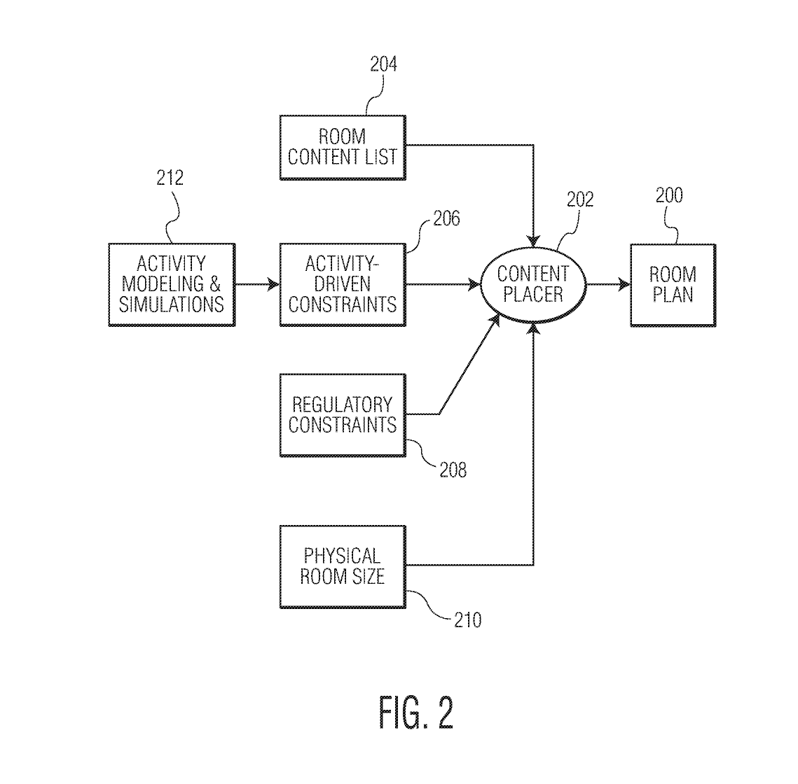

In an embodiment, to utilize a content placer, the architect passes information to the content placer and the content placer generates a room plan. FIG. 2 is a flow chart diagram of the information passed to a content placer 202 that is configured to generate a room plan in accordance with an embodiment of the invention. In an embodiment, a room content list 204, activity-driven constraints 206, regulatory constraints 208, and the physical size of a room 210 are all passed to the content placer. In an embodiment, the room content list includes a list of objects to be placed in a room (e.g., a patient bed, a stool, a desk, a lamp, etc.), the activity-driven constraints are determined by activity modeling and simulations 212 (e.g., a trash can is located next to a sink for paper towels after handwashing or a light switch is located next to the door frame), the regulatory constraints are determined by regulations established by a building owner and/or by a government agency (e.g., style guides from the building owner or fire code), and the physical room size includes the dimensions and shape of the room. In an embodiment of the invention, the activity-driven constraints and the regulatory constraints are expressed using Room Service Rules, which are then passed to the content placer.

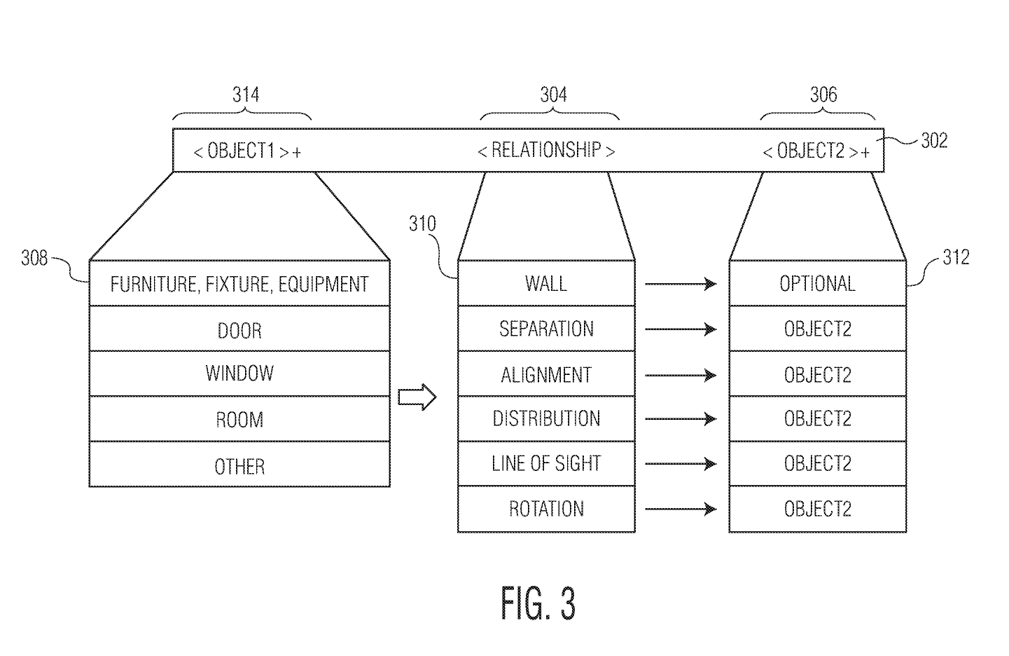

FIG. 3 illustrates the format of a Room Service Rule 302 in accordance with an embodiment of the invention. A Room Service Rule is a parameterized rule statement that can be parsed by, for example, a constraint checker or other method of implementing a content placer in a computer system. In an embodiment, a Room Service Rule has fields 304 in which a handle for a first object and a spatial relationship statement can be inserted and an optional field 306 in which a handle for a second object can be inserted. In an embodiment, objects are divided into five categories as indicated by table 308: “furniture, fixture, equipment” (FFE), “door”, “window”, “room”, and “other,” but additional categories can be used in other embodiments Objects in the FFE category include objects that are not structurally part of the room (e.g., a chair, a trash can, or a sharps bin), objects in the “door” category include objects related to points of entry into the room (e.g., a door or a curtain), the “window” category includes windows, the “room” category includes support elements of a room (e.g., walls, columns, or partitions), and the “other” category includes all other objects. In an embodiment, spatial relationship statements are divided into six categories as indicated by table 310: wall statements, separation statements, alignment statements, distribution statements, line of sight statements, and rotation statements, but other statements can be used in additional embodiments. In an embodiment, a second object is optional for wall statements as indicated by table 312.

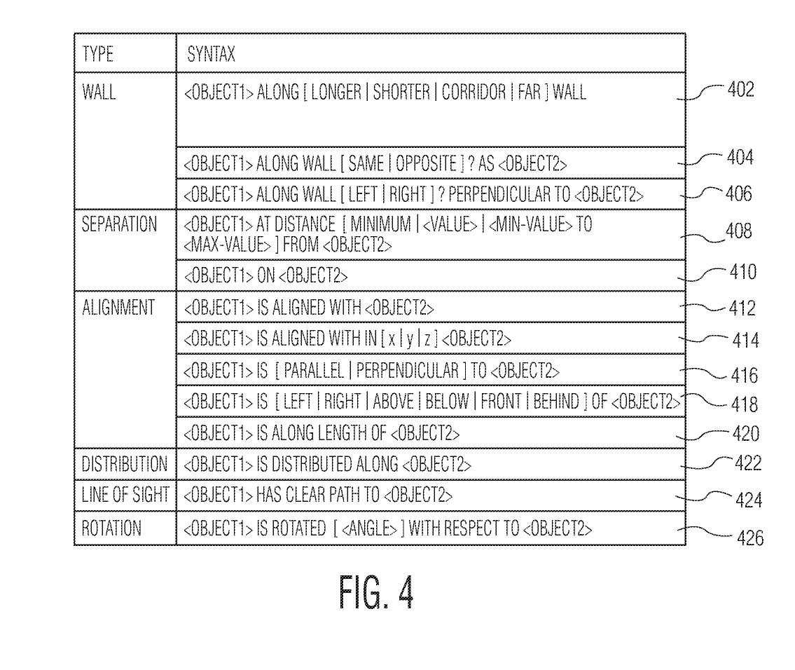

FIG. 4 is a table of spatial relationship statements in accordance with an embodiment of the invention. In an embodiment, the spatial relationship statements are developed by processing a sample set of descriptive language created by human architects to identify a standardized set of statements that can be parsed by the content placer. Spatial relationships statements define a relation between objects in a three dimensional space (e.g., x-direction, y-direction, and z-direction) As shown in FIG. 4, a first wall statement 402 defines a spatial relationship between an object and a wall of a room, a second wall statement 404 defines a spatial relationship between a first object and a wall opposite to a second object, and a third wall statement 406 defines a spatial relationship between a first object and a wall perpendicular to a second object. A first separation statement 408 defines a separation distance between a first object and a second object and a second separation 410 statement defines a first object in direct contact with a second object. In an embodiment, the separation distance between the first object and the second object can be defined as a range. A first alignment statement 412 defines a spatial relationship between a first object aligned with a second object, a second alignment statement 414 defines a spatial relationship between a first object aligned with a second object in the x, y, or z dimension, a third alignment statement 416 defines a first object that is parallel or perpendicular to a second object, a fourth alignment statement 418 defines a first object that is aligned left, right, above, below, in front of, or behind a second object, a fifth alignment statement 420 defines a first object aligned along the length of a second object. A distribution statement 422 defines a first object distributed along a second object. A line of sight statement 424 defines a first object having a clear path to a second object. A rotation statement 426 defines a first object that can be rotated at a defined angled with respect to a second object.

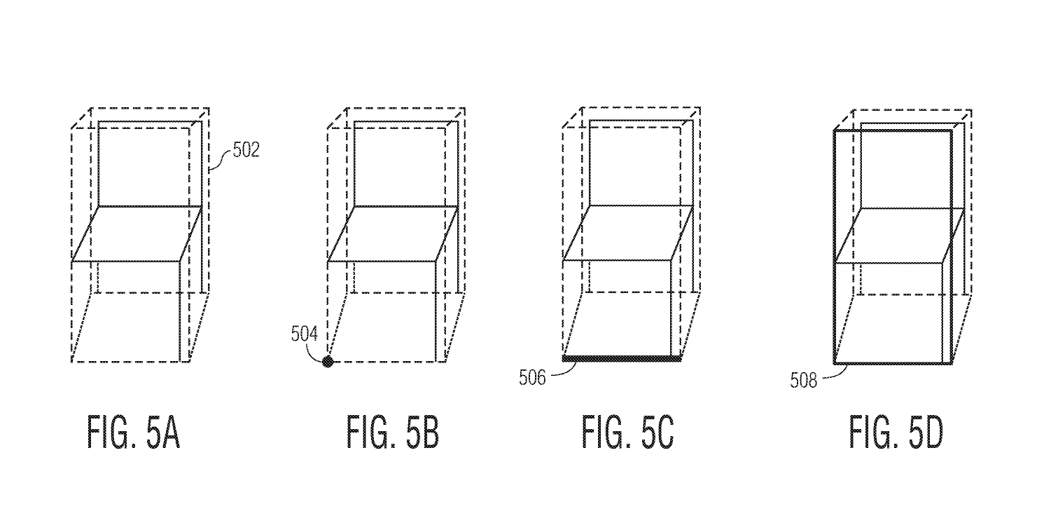

In an embodiment, the relationship statements described with reference to FIG. 3 and FIG. 4 above utilize handles for objects. In an embodiment, a handle can identify an object in a variety of ways. FIG. 5A illustrates an object box 502 and FIGS. 5B-5D illustrate how different handles identify the geometry of the object box in accordance with an embodiment of the invention. The object box of FIG. 5A is a visualization of space occupied around a chair. In the example of FIG. 5A, although the chair is not a perfect cuboid, the object around the chair is treated as a perfect cuboid. The object box is used as a reference shape for defining handles, but in other embodiments, a clearance box (e.g., a box corresponding to the amount of space needed by an object when in use) could be used as the reference shape instead. In an embodiment, handles can be defined by a vertex, face, or edge of the object box. FIG. 5B illustrates a handle defined by a vertex 504. The indicated vertex is referred to as the origin vertex, but a total of eight vertices can be indicated (e.g., one for each corner). FIG. 5C illustrates a handle defined by an edge 506. The indicated edge is the front floor edge of the object box, but a total of twelve edges can be indicated (e.g., each edge between two vertices). FIG. 5D illustrates a handle defined by a face 508. The indicated face is the front face of the object box, but a total of six faces can be indicated (e.g., each side of a cuboid). Different handles are used for different relationship statements. For example, a wall statement might utilize a face handle to indicate which side of an object is against the wall, while a separation rule might utilize vertex handles to indicate between which points the separation distance is measured.

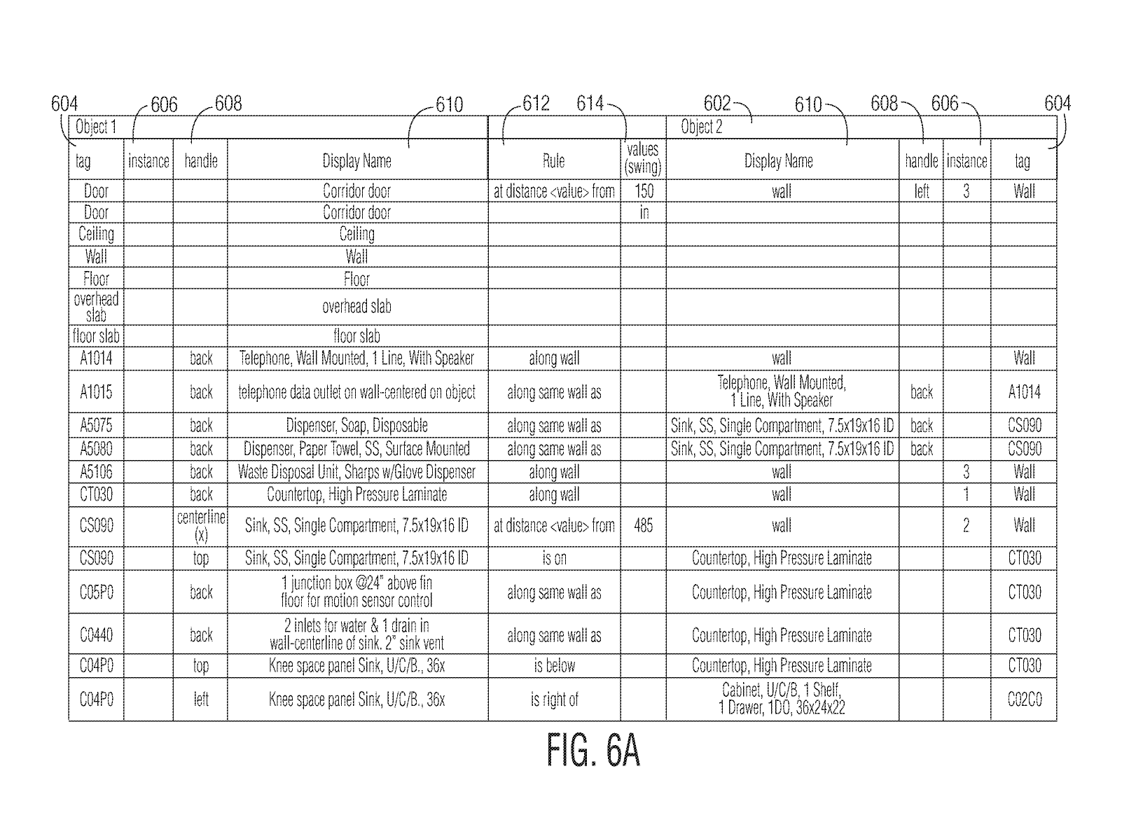

By using Room Service Rules, constraints can be passed to a content placer to generate a room plan. FIGS. 6A-6B are a set of Room Service Rules 602 that describe the room plan of FIG. 1 in accordance with an embodiment of the invention. Each entry in the set indicates (for a first object and optionally for a second object) an object ID (TAG) 604 of an object, the object instance 606 (e.g., wall instance 3 of 4) of the object, a handle for the object 608, and a display name for the object 610. The rule for each entry indicates a relationship statement 612 and a value or range 614 if needed. For example, an “along wall” wall statement will not include a value or range, but an “at distance <value> from” separation statement will include a value (e.g., 150 mm) or a range (e.g., 150 mm-160 mm) corresponding to a separation distance. In an embodiment, the value or range can be defined when the Room Service Rule is added to the set of Room Service Rules or when the set of Room Service Rules are passed to the content placer. In an embodiment, the direction that a door swings is indicated as a value.

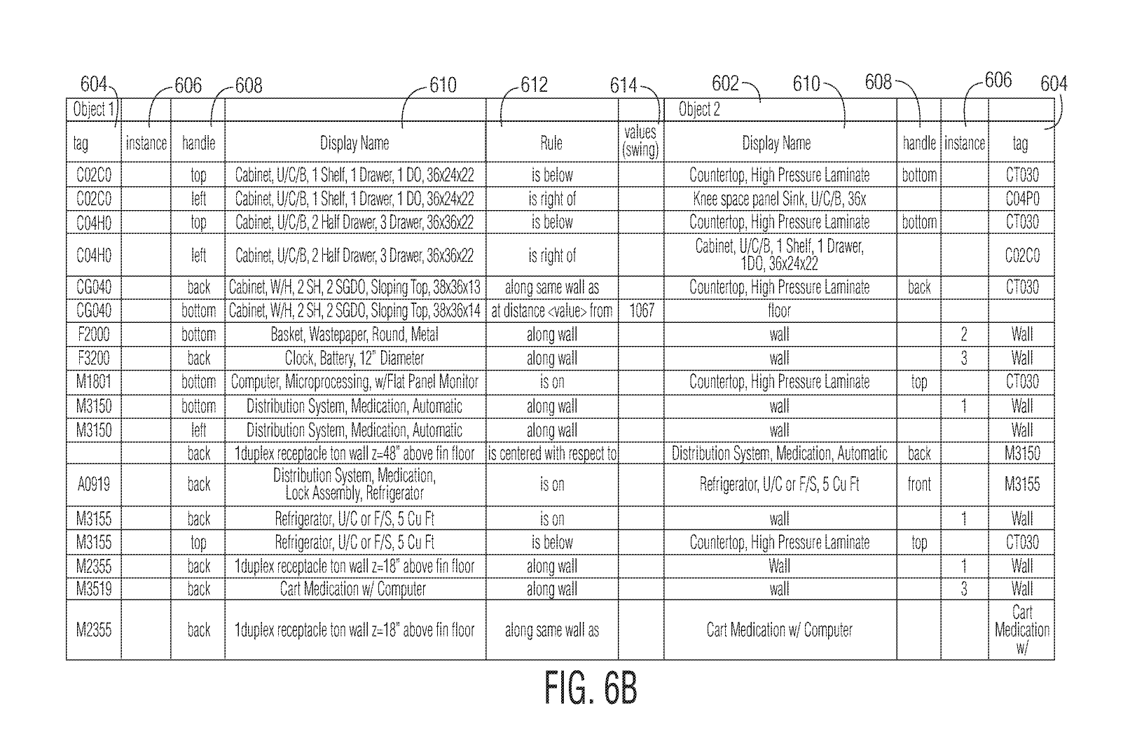

FIG. 7 is a flow chart diagram of a method for generating a room plan in accordance with an embodiment of the invention. At block 702, objects to be placed in a room are determined. In an embodiment, when the object is determined, one or more handles for the object are determined. Once objects are determined, at block 704, relationships between objects are defined by inserting handles and spatial relationship statements into parameters of Room Service Rules as described above. In an embodiment, the relationships can be pre-defined as a profile corresponding to a specific building owner. For example, when generating a room plan for a particular entity (e.g., a particular healthcare organization) with objects that have relationships based on a style guide or proprietary optimization data, a profile for the entity can be passed to the content placer to pre-define the relationships. In another embodiment, the relationships can be pre-defined as a profile corresponding to a specific room type. Room type is determined by the service performed by a given room (e.g., an exam room, a recovery room, or an operating room in a hospital). For example, the relationships between objects of an exam room can be pre-defined by an exam room profile that is passed to a content placer. At block 706, the Room Service Rules are parsed and, at block 708, a placement of objects within the room (room plan) is generated. In an embodiment, if a placement of the objects is not possible, the content placer can return an error or can attempt to place objects within the room while indicating which Room Service Rule or Rules are not satisfied. Once the room plan is generated, the room plan can be displayed on a display device for user consideration.

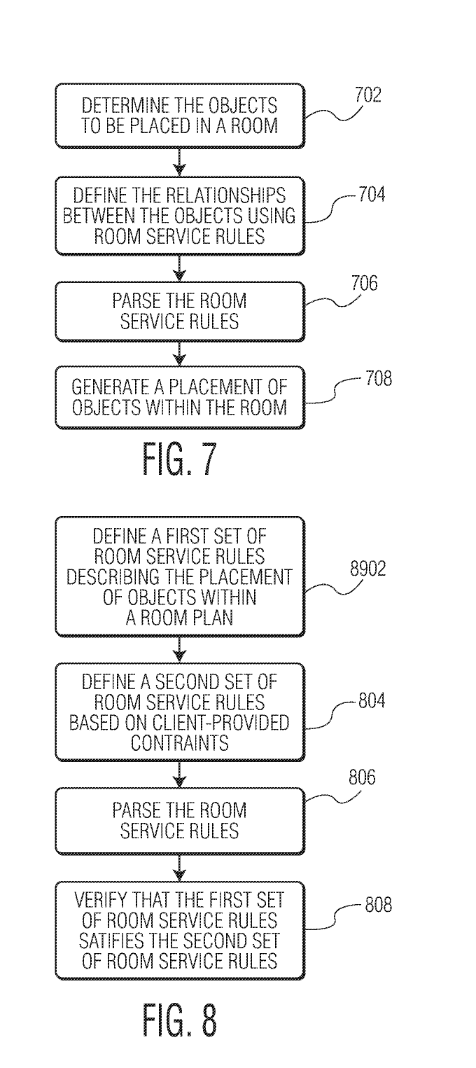

In another embodiment, Room Service Rules can be used in conjunction with a content placer to verify that relationships between objects in a room satisfy a set of Room Service Rules. For example, an architect may design a room plan manually based on constraints provided by a client. The architect can then verify the manually designed room plan by describing the room plan using a first set of Room Service Rules, describing the client-provided constraints using a second set of Room Service Rules, and comparing the two sets of Room Service Rules. FIG. 8 is a flow chart diagram of a method for verifying a room plan in accordance with an embodiment of the invention. At block 802, a first set of Room Service Rules describing the placement of objects within a room plan is defined. At block 804, a second set of Room Service Rules based on client-provided constraints is defined. At block 806, the two sets of Room Service Rules are passed to a content placer and parsed. At block 808, the content placer verifies that the first set of Room Service Rules satisfy the second the second set of Room Service Rules. In an embodiment, a first set of Room Service Rules satisfies a second set of Room Service Rules when all of the rules in the first set are equal to or fall within the range of the rules in the second set. For example, if the first set contains a separation rule with a value of five and the second set contains a separation rule with a range of four to eight, the separation rule of the first set satisfies the separation rule of the second set. In an embodiment, the content placer can notify a user of the results of the verification via a display device.

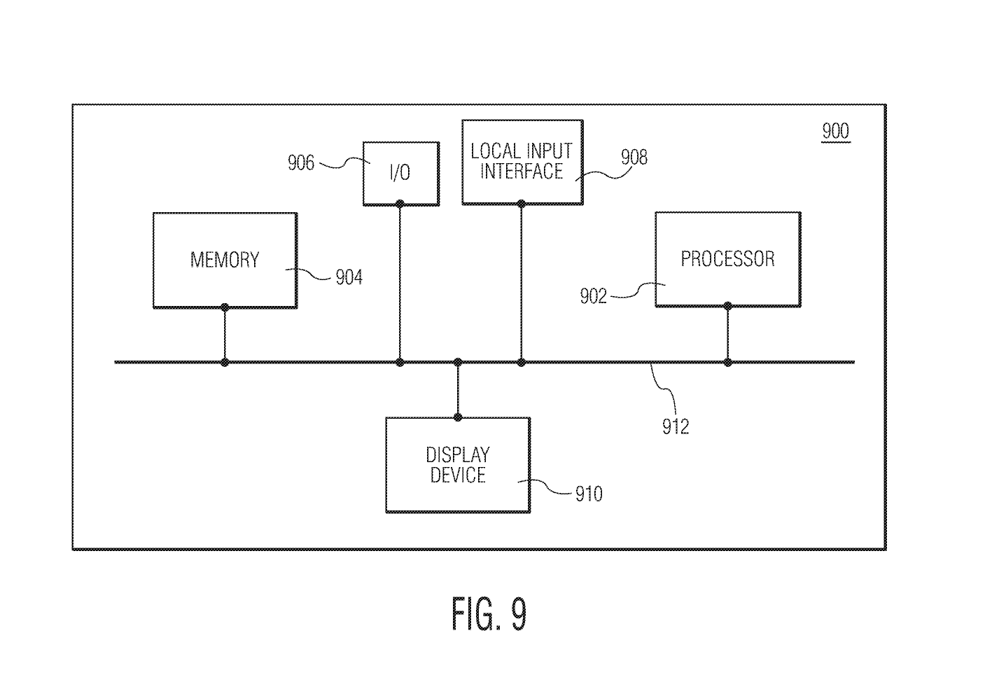

FIG. 9 illustrates a computer 900 having a display device 910 in accordance with an embodiment of the invention. The computer includes a processor 902, memory 904, an I/O interface 906, a local input interface 908, and the display device, which are interconnected by a data bus 912. In an embodiment, the processor may include a multifunction processor and/or an application-specific processor. Examples of processors include the PowerPC™ family of processors by IBM and the x86 family of processors by Intel such as the Xeon™ family of processors and the Intel X5650 processor. The memory within the computer may include, for example, a storage medium such as read only memory (ROM), flash memory, RAM, and a large capacity permanent storage device such as a hard disk drive. The I/O interface enables input from other computers via, for example, Firewire, Ethernet, or USB and the local input interface enables input from, for example, a local user via a keyboard, mouse and/or touch inputs.

The computer 900 executes computer readable instructions stored in the memory 904 using the processor 902 to implement the computer-implemented system described above. In an embodiment, the display device 908 can be integrated into the computer 900, as illustrated in the embodiment of FIG. 9 (e.g., a laptop or tablet computer). Alternatively, the display device can be an external display device that communicates with the computer over a graphical input/output interface, such as a monitor attached by an HDMI cable to a desktop computer or to a network server (not shown).

In additional embodiments, the room plan can be for other rooms in a hospital, such as an operating room, a patient recovery room, a waiting area, a radiology lab, or an administrative support area. Additionally, the system and methods described above can be used to develop room plans for rooms in other building types. For example, a room plan for a hotel room or for an office suite could be generated.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for generating a room plan, the method comprising:
determining objects to be placed in a room;
defining relationships between the objects in the room using Room Service Rules;
parsing the Room Service Rules; and
generating a room plan by passing the parsed Room Service Rules to a content placer;
wherein Room Service Rules are parsable entries that correspond to spatial relationships of the objects to be placed in the room.

2. The method of claim 1, wherein the Room Service Rules comprise a set of parameterized rule statements that allow a user to pass relationship data to a solver.

3. The method of claim 1, wherein the relationships between the objects in the room can be pre-defined based on a profile.

4. The method of claim 1, wherein the relationships between the objects in the room can be pre-defined based on a room type.

5. The method of claim 1, wherein an error is reported if no placement of the objects in the room is possible.

6. A computer-implemented system for defining relationships between objects that are to be included in a room of a building system within which healthcare services will be provided to patients, the computer-implemented system configured to:
identify a first object with a handle, wherein the first object is at least one of furniture, fixtures, and equipment;
identify a second object with a handle; and
define a spatial relationship between the first object and the second object using a spatial relationship statement;
wherein the handle of the first object, the handle of the second object, and the spatial relationship statements are inserted into fields of a parameterized Room Service Rule that can be parsed by a computer-based implementation system.

7. The system of claim 6, wherein a handle identifies an object by at least one of a vertex, an edge, and a face.

8. The system of claim 6, wherein spatial relations are at least one of a relationship with a wall, a separation, an alignment, a distribution, a light of sight, and a rotation relationship.

9. The system of claim 6, wherein the handle indicates a set of one or more objects.

10. The system of claim 6, further configured to pass relationship data to a solver.

11. The system of claim 6, wherein the second object identified is inherent to the Room Service Rule used to define the relationship.

12. The system of claim 6, wherein an object can be a group of objects with defined relationships between the objects in the group.

13. A method for verifying a room plan, the method comprising:
defining a first set of Room Service Rules describing the placement of objects within a room plan;
defining a second set of Room Service Rules based on client-provided constraints;
parsing the Room Service Rules;
verifying that the first set of Room Service Rules satisfy the second set of Room Service rules.

14. The method of claim 13, wherein the Room Service Rules comprise a set of parameterized rule statements that allow a user to pass relationship data to a solver.

15. The method of claim 13, wherein the first set of Room Service Rules can be pre-defined based on a profile.

16. The method of claim 13, wherein the second set of Room Service Rules can be pre-defined based on a profile.

17. The method of claim 13, wherein the relationships between the objects in the room can be pre-defined based on a room type.

18. The method of claim 13, wherein the second set of Room Service Rules specify an acceptable range into which rules in the first set of Room Service Rules can fall.

19. A method for generating a room plan for a room of a building system within which healthcare services will be provided to patients, the method comprising:
determining objects to be placed in a room;
defining relationships between the objects in the room using Room Service Rules;
parsing the Room Service Rules; and
generating a room plan by passing the parsed Room Service Rules to a content placer;
wherein Room Service Rules are parsable entries that correspond to spatial relationships of the objects to be placed in the room.

20. The method of claim 19, wherein the Room Service Rules comprise a set of parameterized rule statements that allow a user to pass relationship data to a solver.

21. The method of claim 19, wherein the relationships between the objects in the room can be pre-defined based on a profile.

22. The method of claim 19, wherein the relationships between the objects in the room can be pre-defined based on a room type.

23. The method of claim 19, wherein an error is reported if no placement of the objects in the room is possible.

24. A computer-implemented system for defining relationships between objects that are to be included in a room plan, the computer-implemented system configured to:
identify a first object with a handle, wherein the first object is at least one of furniture, fixtures, and equipment;
identify a second object with a handle; and
define a spatial relationship between the first object and the second object using a spatial relationship statement;
wherein the handle of the first object, the handle of the second object, and the spatial relationship statements are inserted into fields of a parameterized Room Service Rule that can be parsed by a computer-based implementation system.

25. The system of claim 24, wherein a handle identifies an object by at least one of a vertex, an edge, and a face.

26. The system of claim 24, wherein spatial relations are at least one of a relationship with a wall, a separation, an alignment, a distribution, a light of sight, and a rotation relationship.

27. The system of claim 24, wherein the handle indicates a set of one or more objects.

28. The system of claim 24, further configured to pass relationship data to a solver.

29. The system of claim 24, wherein the second object identified is inherent to the Room Service Rule used to define the relationship.

30. The system of claim 24, wherein an object can be a group of objects with defined relationships between the objects in the group.
